(19) United States
(12) Patent Application Publication
(10) Pub. No.: US 2025/0131395 A1
(43) Pub. Date: Apr. 24, 2025

(54) SYSTEMS, METHODS, AND APPARATUSES FOR PROVIDING MANAGEMENT AND GENERATION OF ELECTRONIC RECEIPTS

(71) Applicant: Charles Edward Beasley, Easley, SC (US)

(72) Inventor: Charles Edward Beasley, Easley, SC (US)

(21) Appl. No.: 18/489,992

(22) Filed: Oct. 19, 2023

(51) Int. Cl. G06Q 20/04; G06Q 20/40

(52) U.S. Cl. CPC G06Q 20/047; G06Q 20/40

(57) ABSTRACT

Systems and methods for electronic receipt management are provided. The system may include a network device that determines completion of a transaction, by an entity, on behalf of a user(s). The network device may receive an electronic receipt(s) by the entity to determine an item(s) of information from the receipt(s) responsive to determining the user(s) has an account associated with facilitating receipts, associated with the user(s), from entities. The network device may predict, by performing machine learning based on analyzing training data associated with prior transactions by the user(s) associated with a historical time period, a category associated with an item(s) associated with the transaction and predicting the entity. The network device may provide a communication to a device of the user. The communication may indicate the predicted category and the entity. The network device may receive an indication from the device indicating whether the transaction is valid or invalid.

### TECHNICAL FIELD

The present disclosure relates generally to methods, apparatuses, and computer program products for providing an electronic system that may provide storage associated with point-of-sale (POS) generated electronic receipts or generated electronic receipts associated with online activities that may be stored in a central location and managed by a centralized entity.

### BACKGROUND

Conventionally, users face several issues in conducting their transactions, online and at point-of-sale (POS) checkout stations, such as obtaining or organizing receipts. Tasks to manage receipts may be cumbersome or inefficient.

This background information is provided to reveal information believed by the applicant to be of possible relevance. No admission is necessarily intended, nor should be construed, that any of the preceding information constitutes prior art.

### BRIEF SUMMARY

Users may receive a paper receipt (e.g., at POS stations) or electronic receipt (e.g., online). Some users may also establish time to manually reconcile the receipts to various folders for tracking purposes. Additionally, users may arrange for space to store their paper receipts temporarily or permanently. These user related tasks to manage receipts may be cumbersome or inefficient. Therefore, there may be a need for a receipt management system that manages each of the receipts in one location with a reconciliation system that may be real-time and addresses the issues mentioned herein.

The examples of the present disclosure may provide an electronic system or a repository that may provide storage for all, or a subset receipts generated via POS, online, or in other manners in one location. The electronic system of the examples of the present disclosure may also be referred to herein as a Beyond Receipts (BR) system. Each user that uses the system may have their own secure account (e.g., user profile) or webpage that may be accessed to reconcile or monitor receipts linked to the account. An account may have multiple subaccounts, such as family group that includes one or more parents and one or more children or business group which may include one or more employees. The system may be accessible 24 hours a day, 7 days a week.

The system of the present disclosure may provide an application (app) such as, for example, a mobile app that may allow access, in real-time, to transactions, maximize the efficiency of reconciliation and cataloging of receipts in the system, or may allow for tracking of multiple accounts. In some examples, the application may be able to be synced to a user's account (e.g., a Beyond Receipts account) once the account is established. In other examples, a Beyond Receipts website may be used to access, in real-time, transactions, maximize the efficiency of reconciliation, or for cataloging of receipts in the system.

The disclosed methods and systems may provide electronic receipt generation or electronic receipt management. The system may provide a storage location for receipts, thus significantly reducing the use of paper receipts or providing numerous benefits to a purchasing entity (e.g., user, such as an individual consumer or business) as well as a selling entity (e.g., merchant that is selling goods or services). The system may be accessible in multiple ways depending on the need of the entity. Each entity may have a password-protected account with sufficient security protocols to guard against hackers or malicious activity.

A user (e.g., a purchaser, merchant, entity) may access a website (e.g., a BR website) to register for an account(s). A template questionnaire may be filled out to determine whether a user may activate an account(s). Once the account(s) is activated, the user may download the app (e.g., BR app) onto a communication device (e.g., smartphone, mobile device, tablet, computer, etc.) and link the app to their account (e.g., BR account). The system may allow 24/7 access to the user's account via a device or app. The system may also help facilitate some of the processes offered by the system, saving time or providing real-time updates.

The BR system may be able to accept electronic receipts from POS terminals, online stores/entities, emails, texts, scans, or the like. Uploaded receipts may be analyzed for legibility and, if the receipts are deemed acceptable, then the receipts may be transferred to a storage location (e.g., a holding area associated with the user's account (e.g., a repository within or associated with a memory)). These receipts may be utilized by the BR system in association with a reconcile process, as described herein.

In an aspect of the present disclosure, a method may include determining completion of a transaction, facilitated by an entity, on behalf of at least one user. The method may further include receiving at least one electronic receipt generated by the entity to determine one or more items of information from the electronic receipt in response to determining that the at least one user comprises a user account associated with facilitating electronic receipts from one or more entities. The electronic receipts may be associated with the at least one user. The method may further include predicting at least one category associated with one or more items associated with the transaction and predicting the entity. The predicting of the at least one category and the predicting of the entity may be by the network device by performing machine learning based on analyzing items of training data associated with one or more determined prior transactions by the at least one user associated with a historical time period. The method may further include providing, by the network device, a generated communication to a device of the user. The communication may indicate the predicted at least one category and the predicted entity. The method may further include receiving an indication from the device indicating whether the transaction is valid or invalid.

In another aspect of the present disclosure, an apparatus may include at least one processor and a memory including computer program code instructions. The memory and computer program code instructions are configured to, with at least one processor, cause the apparatus to at least perform operations including determining completion of a transaction, facilitated by an entity, on behalf of at least one user. The memory and computer program code are also configured to, with the processor, cause the apparatus to receive at least one electronic receipt generated by the entity to determine one or more items of information from the electronic receipt in response to determining that the at least one user comprises a user account associated with facilitating electronic receipts from one or more entities. The electronic receipts may be associated with the at least one user. The memory and computer program code are also configured to, with the processor, cause the apparatus to predict at least one category associated with one or more items associated with the transaction and predicting the entity. The predicting of the at least one category and the predicting of the entity may be by the apparatus by performing machine learning based on analyzing items of training data associated with one or more determined prior transactions by the at least one user associated with a historical time period. The memory and computer program code are also configured to, with the processor, cause the apparatus to provide a generated communication to a device of the user. The communication may indicate the predicted at least one category and the predicted entity. The memory and computer program code are also configured to, with the processor, cause the apparatus to receive an indication from the device indicating whether the transaction is valid or invalid.

In yet another aspect of the present disclosure, a computer program product may include at least one computer-readable storage medium having computer-executable program code instructions stored therein. The computer-executable program code instructions may include program code instructions configured to determine completion of a transaction, facilitated by an entity, on behalf of at least one user. The computer program product may further include program code instructions configured to receive at least one electronic receipt generated by the entity to determine one or more items of information from the electronic receipt in response to determining that the at least one user comprises a user account associated with facilitating electronic receipts from one or more entities. The electronic receipts may be associated with the at least one user. The computer program product may further include program code instructions configured to predict at least one category associated with one or more items associated with the transaction and predicting the entity. The predicting of the at least one category and the predicting of the entity may be by the network device by performing machine learning based on analyzing items of training data associated with one or more determined prior transactions by the at least one user associated with a historical time period. The computer program product may further include program code instructions configured to provide, by the network device, a generated communication to a device of the user. The communication may indicate the predicted at least one category and the predicted entity. The computer program product may further include program code instructions configured to receive an indication from the device indicating whether the transaction is valid or invalid.

This Brief Summary is provided to introduce a selection of concepts in a simplified form that are further described below in the Detailed Description. This Brief Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an exemplary system that may be used to implement the electronic receipt generation or management system as disclosed herein;

FIG. 2 illustrates a communication device in accordance with an example of the present disclosure;

FIG. 3 illustrates a computing system in accordance with an example of the present disclosure;

FIG. 4 illustrates a machine learning and training model in accordance with an example of the present disclosure;

FIG. 5 illustrates a graphical interface in accordance with an example of the present disclosure;

FIG. 6 illustrates header information associated with one or more electronic receipts in accordance with an example of the present disclosure;

FIGS. 7A and 7B illustrate a process of electronic receipt generation or management by a system in accordance with an example of the present disclosure;

FIG. 8 illustrates a process of electronic receipt generation or management by a system in accordance with an example of the present disclosure;

FIG. 9 illustrates an exemplary process of electronic receipt generation or management according to an example of the present disclosure.

The figures depict various examples for purposes of illustration only. One skilled in the art will readily recognize from the following discussion that alternative examples of the structures or methods illustrated herein may be employed without departing from the principles described herein.

### DETAILED DESCRIPTION

Some examples will be described more fully hereinafter with reference to the accompanying drawings, in which some, but not all examples are shown. Indeed, various examples may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received, or stored in accordance with the examples. Moreover, the term “exemplary”, as used herein, is not provided to convey any qualitative assessment, but instead merely to convey an illustration of an example. Thus, use of any such terms should not be taken to limit the spirit and scope of the examples.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, header information may be general information on or associated with a receipt(s) that may provide a summary of one or more receipts associated with a user(s) and may be included in a document, file, or the like (e.g., a sheet(s) in a document that provides a summary of one or more receipts). The header information may include, but is not limited to, content associated with a vendor name, an identifier (ID) number (e.g., a Beyond Receipts ID number), a user ID number (e.g., a user Beyond Receipts ID number), a date and/or a time associated with a transaction(s), and/or a total amount associated with a receipt(s) corresponding to the transaction(s).

As referred to herein, mark items or marking items may refer to mechanisms for a user(s) to choose to mark one or more receipts associated with one or more purchases. For purposes of illustration and not of limitation, the marking items may be utilized for tracking purposes that may allow a user(s) to search for and retrieve a corresponding receipt(s) associated with one or more designated/marked categories. For purposes of illustration and not of limitation, the categories may be associated with tax reporting, to provide proof of one or more warranties, for expense report filing or any other suitable categories.

### Exemplary System Operation

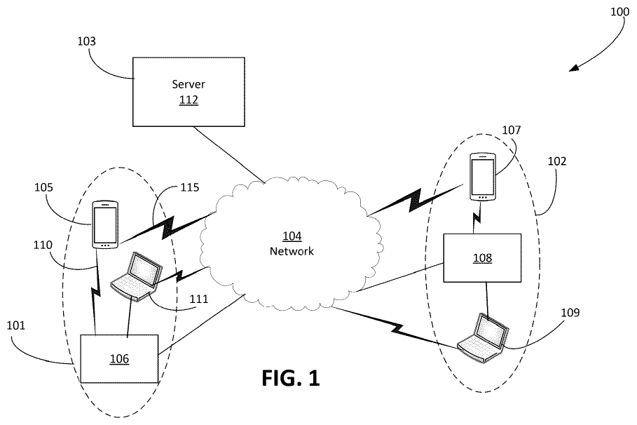

FIG. 1 illustrates an exemplary system 100 that may be used to implement the electronic receipt generation or management system as disclosed herein. In some examples, the system 100 may also be referred to herein as a BR system 100. As shown, there may be a merchant station 101 and a merchant site 102. Merchant station 101 may be associated with device 106, while merchant site 102 may be associated with device 108. As provided in more detail herein, device 106 or device 108 may be point-of-sale (POS) terminals/stations, for example, at a physical store of a merchant or servers that may facilitate ordering of goods or services via a network (e.g., online). Communication device 105, communication device 107, communication device 109, or communication device 111 may be associated with a user. In some examples, communication devices 105, 107, 109, 111 may be electronic devices including hardware, software, or embedded logic components or a combination of two or more such components and capable of carrying out the appropriate functionalities implemented or supported by the communication devices 105, 107, 109, 111. As an example, and not by way of limitation, the communication devices 105, 107, 109, 111 may be a computer system such as a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, mobile phone, or any other suitable electronic device, or any suitable combination thereof. The communication devices 105, 107, 109, 111 may enable one or more users to access network 104. The communication devices 105, 107, 109, 111 may enable a user(s) to communicate with other users at other communication devices 105, 107, 109, 111. Communication devices 105, 107, 109, 111, device 106, device 108, or network device 103 may be communicatively connected with each other via communication network 104. This disclosure contemplates any suitable network 104. As an example and not by way of limitation, one or more portions of network 104 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 104 may include one or more networks 104.

Network device 103 (e.g., a server) may be accessed by the other components of system 100 directly or via network 104. The network device 103 may include a server 112. As an example and not by way of limitation, communication devices 105, 107, 109, 111, device 106, or device 108 may access network device 103 using a web browser or a native application associated with network device 103 (e.g., a mobile application, a messaging application, another suitable application, or any combination thereof) directly or via network 104. In particular examples, network device 103 may include one or more servers 112. Each server 112 may be a unitary server or a distributed server spanning multiple computers or multiple datacenters. Servers 112 may be of various types, such as, for example and without limitation, web server, news server, mail server, message server, advertising server, file server, application server, exchange server, database server, proxy server, another server suitable for performing functions or processes described herein, or any combination thereof. In particular examples, each server 112 may include hardware, software, or embedded logic components or a combination of two or more such components for carrying out the appropriate functionalities implemented or supported by server 112. Particular examples may provide interfaces that enable communication devices 105, 107, 109, 111, device 106, device 108 or another system (e.g., a third-party system) to manage, retrieve, modify, add, or delete information.

It should be pointed out that although FIG. 1 shows one network device 103 and four communication devices 105, 107, 109, 111 or two devices 106, 108 any suitable number of network devices 103 and communication devices 105, 107, 109, 111 and devices 106, 108 may be part of the system of FIG. 1 without departing from the spirit and scope of the present disclosure.

### Exemplary Communication Device

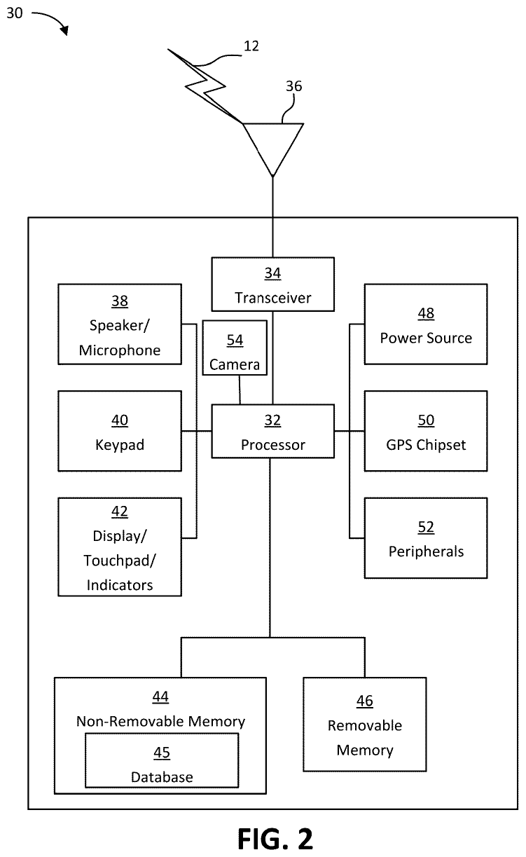

FIG. 2 illustrates a block diagram of an exemplary hardware/software architecture of a communication device 30. In some examples, the communication device 30 may be any of communication devices 105, 107, 109, 111, device 106, or device 108. In some examples, the communication device 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, mobile phone, mobile device, or any other suitable electronic device. As shown in FIG. 2, the communication device 30 may include a processor 32, non-removable memory 44, removable memory 46, a speaker/microphone 38, a keypad 40, a display, touchpad, or indicators 42, a power source 48, a global positioning system (GPS) chipset 50, or other peripherals 52. The power source 48 may be capable of receiving electric power for supplying electric power to the communication device 30. For example, the power source 48 may include an alternating current to direct current (AC-to-DC) converter allowing the power source 48 to be connected/plugged to an AC electrical receptable or Universal Serial Bus (USB) port for receiving electric power. The communication device 30 may also include a camera 54. In an example, the camera 54 may be a smart camera configured to sense images/video appearing within one or more bounding boxes. The communication device 30 may also include communication circuitry, such as a transceiver 34 or a transmit/receive element 36. It will be appreciated the communication device 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 or memory 46) of the communication device 30 in order to perform the various required functions of the communication device. For example, the processor 32 may perform signal coding, data processing, power control, input/output processing, or any other functionality that enables the communication device 30 to operate in a wireless or wired environment. The processor 32 may run application-layer programs (e.g., browsers) or radio access-layer (RAN) programs or other communications programs. The processor 32 may also perform security operations such as authentication, security key agreement, or cryptographic operations, such as at the access-layer or application layer for example.

The processor 32 is coupled to its communication circuitry (e.g., transceiver 34 and transmit/receive element 36). The processor 32, through the execution of computer executable instructions, may control the communication circuitry in order to cause the communication device 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit or receive radio frequency (RF) signals. The transmit/receive element 36 may support various networks and air interfaces, such as wireless local area network (WLAN), wireless personal area network (WPAN), cellular, or the like. In yet another example, the transmit/receive element 36 may be configured to transmit or receive both RF and light signals. It will be appreciated that the transmit/receive element 36 may be configured to transmit or receive any combination of wireless or wired signals.

The transceiver 34 may be configured to modulate the signals that are to be transmitted by the transmit/receive element 36 and to demodulate the signals that are received by the transmit/receive element 36. As noted herein, the communication device 30 may have multi-mode capabilities. Thus, the transceiver 34 may include multiple transceivers for enabling the communication device 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 or the removable memory 46. For example, the processor 32 may store session context in its memory, as described herein. The non-removable memory 44 may include RAM, ROM, a hard disk, or any other type of memory storage device. The non-removable memory 44 may include a database 45. In some examples, the database 45 may store any suitable data (e.g., receipts), content or the like. The removable memory 46 may include a subscriber identity module (SIM) card, a memory stick, a secure digital (SD) memory card, and the like. In other examples, the processor 32 may access information from, and store data in, memory that is not physically located on the communication device 30, such as on a server, or a home computer.

The processor 32 may receive power from the power source 48, and may be configured to distribute or control the power to the other components in the communication device 30. The power source 48 may be any suitable device for powering the communication device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, or the like. The processor 32 may also be coupled to the GPS chipset 50, which may be configured to provide location information (e.g., longitude and latitude) regarding the current location of the communication device 30. It will be appreciated that the communication device 30 may acquire location information by way of any suitable location-determination method while remaining consistent with an example.

### Exemplary Computing System

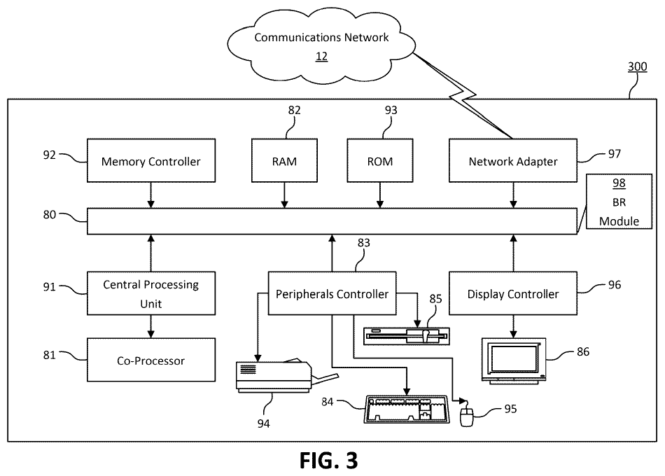

FIG. 3 is a block diagram of an exemplary computing system 300. In some examples, the network device 103 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus. In some examples, the computing system 300 may host one or more websites (e.g., a BR website(s)). In some examples of the present disclosure, the computing system 300 may include a Beyond Receipts (BR) module 98. The BR module 98 may facilitate management and handling of generated electronic receipts associated with purchases of goods, services or donations made at POS stations or associated with online entities (e.g., websites associated with stores, merchants or other entities). Additionally, the BR module 98 may perform other suitable functions.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, or disk drive 85.

Display 86, which is controlled by display controller 96, is used to display visual output generated by computing system 300. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., communication device 30) of the network.

### Exemplary Framework

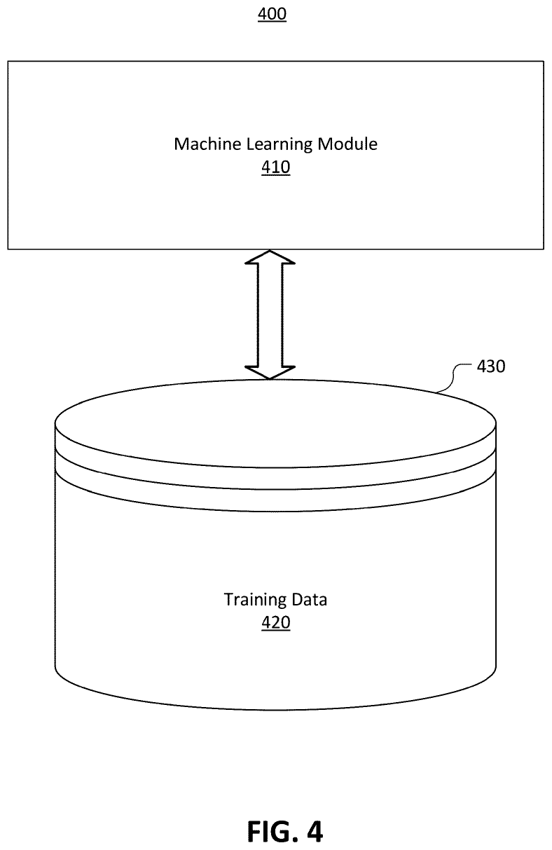

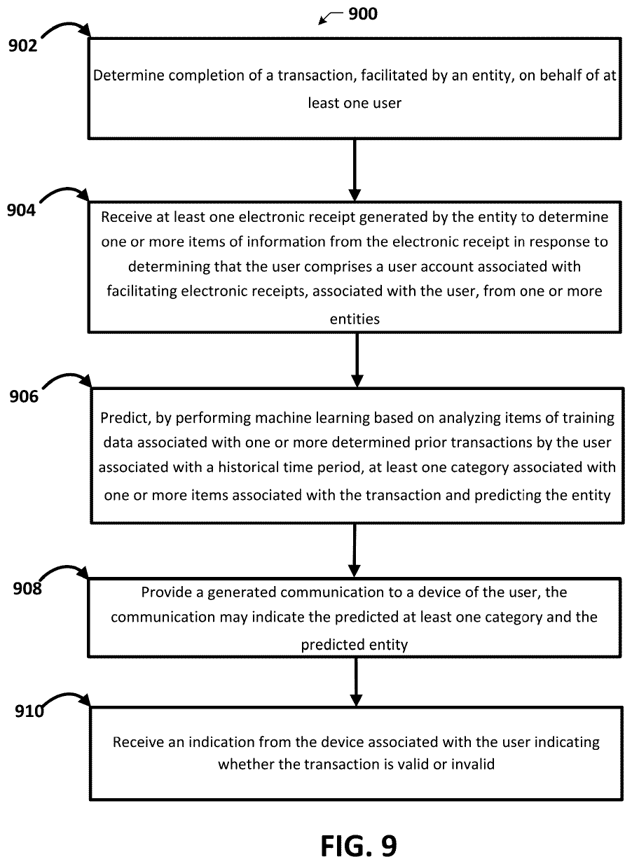

FIG. 4 illustrates a framework 400 employed by a software application for facilitating determination of categories of items or entities in some examples. The framework 400 may be hosted remotely. Alternatively, the framework 400 may reside within the network device 103 or the communication device 30 shown in FIG. 2 or be processed by the computing system 300 shown in FIG. 3. The machine learning model 410 may be operably coupled with the stored training data in a database 430. In some examples, the machine learning model 410 may be associated with operations of FIG. 9 or other methods disclosed herein. In some other examples, the machine learning model 410 may be associated with other operations. The machine learning model 410 may be implemented by one or more machine learning modules or another device (e.g., network device 103).

In an example, the training data 420 may include attributes of thousands of objects. For example, the objects may, but need not be, content items (e.g., messages, notifications, electronic receipts, images, videos, audio), or the like. For instance, in some examples the content items may be associated with indications of types of purchases/transactions performed by one or more users, determinations associated with entities in which the one or more users may make purchases (e.g., shopping entities, stores, etc.), donations and determinations of categories of types of items associated with one or more purchases/transactions. Attributes may include but are not limited to a size, shape, orientation, position of the object(s), etc. The training data 420 employed by the machine learning model 410 may be fixed or updated periodically. Alternatively, the training data 420 may be updated in real-time based upon the evaluations performed by the machine learning model 410 in a non-training mode. This is illustrated by the double-sided arrow connecting the machine learning model 410 and stored training data 420.

In some examples, the machine learning model 410 may be trained, based on the training data described herein to determine/predict one or more categories of items associated with purchases/transactions by a corresponding user(s) or determine/predict the entities from which a user(s) may perform current (e.g., in real-time) purchases/transactions or entities that the user(s) interacts/engages with currently (e.g., in real-time).

### Exemplary System Operation

The examples of the present disclosure may provide receipt management that maintains the integrity of electronic receipts, which may eliminate a need for paper receipts to be printed, as well as may consolidate receipts from various merchant, vendor, service, or the like in a repository (e.g., a cloud-based repository). The examples of the present disclosure may also provide a receipt management system that has a reconciliation or categorization process that may be interactive, manageable, and time-efficient. For instance, in some examples, the time that it may take a user to reconcile a receipt(s) upon receiving a notification associated with the receipt from the BR system may be within less than half a minute. The user may be able to perform this reconciliation of the receipt(s) on the go/fly, which may be very efficient and convenient.

As described herein, the systems of the present disclosure may significantly reduce or eliminate a need for paper receipts. In this regard, the systems of the present disclosure may be green systems (e.g., eco-friendly for the environment). For example, the systems of the present disclosure may reduce or help minimize paper receipts which may conserve natural resources or reduce waste in land fields associated with paper receipts. The systems of the present disclosure may provide reconciliation, categorization, tracking, or fraud detection processes as described herein. The systems of the present disclosure may also provide a consolidated repository for each/all of the receipts (e.g., POS-generated, online, email, texted) associated with the system. With receipts, associated with the examples of the present disclosure, being stored in a digital repository, the receipts may become more accessible and may no longer be a storage concern for users or may no longer be a cumbersome process to users (unlike with some conventional systems).

The reconcile process provided by some of the examples of the present disclosure may save users time in reconciling their receipts into the system. In this regard, for example, users may be able to complete the process of reconciling a receipt(s) in less than a minute. For instance, the reconciling of a receipt may be associated with a communication (e.g., notification) being immediately sent to a user by the BR system requesting confirmation of a purchase/transaction, associated with a receipt, by the user. For purposes of illustration and not of limitation, a user may receive a notification via an app (e.g., a mobile app) indicating that the user has a receipt to reconcile. The user may utilize a communication device (e.g., communication device 30) to open the notification which may be shown on a display associated with a user interface. The user may interact with the notification via the user interface and may make indications and/or selections to categorize the receipt, and/or mark the receipt with designated tags, and may submit the notification for finalization and storage by the BR system. In some examples, this process may take less than a minute to complete by the user.

Referring back to FIG. 1, for purposes of illustration and not of limitation, in an example, a merchant station 101 may be a physical business location that may include device 106 (e.g., POS terminal). Communication device 105 may be associated with a first user. In this example, the first user may use a debit card at device 106 to purchase tools. A transaction may be completed, and a receipt (e.g., an electronic receipt) associated with the transaction may be generated on behalf of the first user by the network device 103. The receipt may detail the tools purchased, their corresponding price, type of payment, standard alpha or numeric identifier for tool or type of transaction, etc. The receipt may be automatically associated, by the network device 103, with the first user based on the mechanism of payment (e.g., debit card number, mobile phone identifier (ID), or in the example of cash, a user profile entered into a POS terminal). After the electronic receipt is generated, the network device 103 may initiate a process to reconcile the receipt. The system 100 may be configured such that responsive to generating the receipt, the network device 103 may send an alert to communication device 105 (e.g., a mobile device) in order to verify the receipt for reconciliation, as described herein.

In some examples, in an instance in which the alert is received by communication device 105, the receipt may be verified based on an indication (e.g., selection of Yes or No) that the receipt is valid or a user authentication indication (e.g., text password, fingerprint recognition, facial recognition, etc.). In some examples, a BR app may provide one or more measures of security such as, for example, two-factor authentication and/or biometric scanning/reading associated with a user to facilitate access by the user via a communication device (e.g., communication device 30) to the BR system. The verification and authentication may occur after every purchase/transaction or periodically based on certain factors which may be associated with unusual or fraudulent behavior. In some examples, the alert may be sent to communication device 105 over a wireless wide area network link 115 (e.g., LTE or 5G) or over a wireless local area network link 110 (e.g., Bluetooth or Wi-Fi).

With further regards to FIG. 1, in another example, a merchant 102 may be an online store (e.g., an entity maintaining a website) that may utilize device 108 (e.g., a server) to assist with purchases/transactions. Communication device 107 may be associated with a second user. In an example, the second user may enter a debit card to purchase tools from merchant 102. A transaction may be completed, and a receipt (e.g., an electronic receipt) of the transaction may be generated for the second user, by the network device 103, and may be stored in a memory (e.g., RAM 82) associated with the network device 103. The receipt may detail the tools purchased, their corresponding price, type of payment, etc. The receipt may be automatically associated with, by the network device 103, the second user based in part on the mechanism of payment (e.g., debit card number, or mobile phone ID). As described herein, in response to the receipt being generated, the network device 103 may initiate a process to reconcile the receipt, as described herein.

In some examples, the process for receipt management within the BR system 100 may include three phases, such as receipt acquisition, reconciliation, or storage/management. Each of these phases may include their own processes. In other examples, the process for receipt management within the BR system 100 may include more than three phases or in other examples may include less than three phases.

### Receipt Acquisition

As described herein, the BR system may help eliminate paper within the receipt process. In some examples, the receipt acquisition phase of the system 100 may be initiated based on an interaction/communication with a device 106 or device 108 (e.g., POS terminal or an online entity, such as a checkout system of an online store). In some examples, the network device 103 of the BR system 100 may interface with the device 106 or device 108 based on the devices 106, 108 communicating with the network device 103 via an application (e.g., an app (e.g., a BR app) or a software patch). For any entities (e.g., merchants) or systems that may not utilize the application (e.g., the BR app), the receipts associated with a transaction(s) with these entities or systems may be received by the network device 103 of the BR system 100 based on an electronic mail (email) communication and/or other communication/notification (e.g., Short Message Service (SMS) message (e.g., text)), as described herein.

In some examples, the app may enable the network device 103 to interface/communication with a device 106 (e.g., POS station), device 108 (e.g., a device associated with an online entity (e.g., online checkout system) or another communication device(s) such as, for example, communication devices 109, 111). The user of a device (e.g., communication device 105) having the BR app (and thus a BR account) may be enabled, via the BR app, to input their BR account number into the BR app during a checkout process, associated with a purchase of a good(s) or service(s) or other transaction(s), which may enable a receipt to be generated by a device (e.g., device 106 or device 108). The generated receipt may be provided by the device (e.g., device 106 or device 108) to the network device 103 which may store the receipt in association with the user's BR account. In some examples, devices of the merchant stations (e.g., merchant stations 101, 102) may include the BR app.

In some other examples, a user may be able to input their BR identifier (e.g., email address, mobile phone number, or messaging identifier, etc.), via a device (e.g., device 106, device 108) during a checkout process, associated with a purchase(s), or transaction(s), when prompted. For instance, users having BR accounts may be provided a Beyond Receipts email address for their account upon registration (e.g., firstname.lastname@BR.com). By inputting the BR email address, the receipt generated by a device (e.g., device 106) of a merchant station (e.g., merchant station 101, 102) may then be sent directly by the device, such as device 106 to the network device 103 to enable the network device 103 to process the receipt on behalf of the user's BR account. Both processes may be electronic, and the consumer may be assured that they have a receipt within minutes of the transaction(s) through the reconciliation process which is discussed in detail herein. In some alternative examples, in instances in which some merchants (e.g., merchant stations 101, 102) may not have the BR app included on their devices (e.g., devices 106, 108), these merchants may enable utilization of the BR email addresses to enable receipts generated by their devices to be sent/communicated to the network device 103. The mechanism of utilizing the BR app or the mechanism of utilizing the users BR identifier, described herein, may enable generation of electronic receipts in a time efficient manner (e.g., within minutes of a transaction) through/via a reconciliation process which is described herein.

As described above, email may be utilized to transfer a receipt(s) into the BR system (e.g., BR system 100). There may be two approaches to achieve the transfer of a receipt into the BR system. As described above, a user may enter their BR email address at either POS station or an online checkout system for the corresponding receipt to be sent to the network device 103 which may process the receipt and associate the receipt with the user's BR account. The network device 103 may perform object character recognition (OCR) on the receipt and may scan the receipt for header information, which once retrieved by the network device 103 may trigger the network device 103 to initiate the reconcile process by generating a notification of the receipt to be sent to a communication device (e.g., communication device 107) of the user.

In some other examples of the present disclosure, another manner in which email may be utilized to have receipts provided to the BR system (e.g., BR system 100) is to have the receipt emailed to the user's personal email account. The user may log into the BR system and access their BR account and may drag and drop the receipt from their personal email account into the user's BR account for processing (e.g., by the network device 103). The network device 103 may perform object character recognition on the receipt and may scan the receipt for header information and once the header information is obtained, the network device 103 may initiate the reconcile process and may generate the notification of the receipt to be sent to a communication device of the user.

For receipts that may be sent to a user via SMS such as text message (e.g., by device 106 (e.g., a POS station), the receipt may be emailed by the user's communication device (e.g., communication device 107, etc.) to the user's BR email address to enable access of the receipt by the BR system (e.g., BR system 100). In this regard, the network device 103 may receive the receipt and process the receipt in a similar manner as described above.

### Receipt Reconciliation

Once the receipt is received by the network device 103 of the BR system 100 or the network device 103 associates the receipt with the corresponding user's account, the network device 103 may send a communication (e.g., an alert, a notification) indicating an associated transaction, such as an electronic receipt, to the user's communication device(s) (e.g., communication devices 105, 107, 109, 111) which may be indicated by the BR app. In some other examples, the communication (e.g., the alert, notification, etc.) may be sent by the network device 103 to a communication device(s) of the user via a SMS message (e.g., a text message) or to an email address (e.g., a BR email address) of the user or in any other suitable manner. In this manner, the communication device of the user may receive the communication indicating the electronic receipt in a time efficient manner (e.g., within two minutes of a purchase/transaction, within 1.5 minutes, etc.). The communication device of the user receiving the communication regarding the electronic receipt may enable the user to perform multiple actions in a time efficient manner (e.g., in less than one minute) to finalize the receipt for storage into a BR repository of a memory device (e.g., RAM 82). It is contemplated herein that one or more receipts may be stored locally or stored remotely, which may be based on device storage capacity or network access.

In this regard, the user may utilize the electronic receipt to 1) verify a transaction(s) (e.g., a purchase(s) associated with the electronic receipt), 2) assign the electronic receipt to be categorized to a designated folder, or 3) earmark the electronic receipt for tracking (e.g., to track taxes, warranties, expense reporting, a combination thereof, or for other purposes).

### Verify the Purchase

By receiving the communication (e.g., the alert, notification) indicating the electronic receipt soon after an associated transaction (e.g., regarding a purchase, donation, etc.), a user may be able to confirm, via their device(s) (e.g., communication device 105, 107, 109, 111) or via the BR app, that the user has evidence (e.g., digital evidence) of the transaction. By enabling the user to confirm the electronic receipt, this may enable the network device 103 (e.g., the BR module 98 of the network device) of the system 100 to determine that there is no fraud associated with the transaction. For example, the user may utilize a user interface of their device(s) to select Yes or No regarding whether the user performed the transaction(s) associated with the electronic receipt and in response to the indication of the selection, the device(s) of the user may provide an indication of the selection of Yes or No to the network device 103. In an instance in which the user selects No from the user interface of their associated device(s), such an indication of No may indicate to the network device 103 that the transaction(s) associated with the electronic receipt is fraudulent (e.g., fraudulently performed by another user or entity).

In this manner, as an example, the indication of fraud associated with the transaction may be indicated, by the network device 103, to other systems (e.g., automated accounting systems, etc.) such as bank entities, credit card entities or the like. In this regard, the bank entities, credit card entities or the like may be informed/aware that fraud may exist associated with the transaction(s) corresponding to the electronic receipt and may stop the payment from issuing associated with the transaction(s).

In some other examples, fraud may be determined in an instance in which a user may download a purchase summary and an accounting module on the commination device (e.g., communication device 105) of the user may cross reference purchases with bank account/credit card account information or may determine one or more discrepancies indicating fraud

### Categorize the Receipt

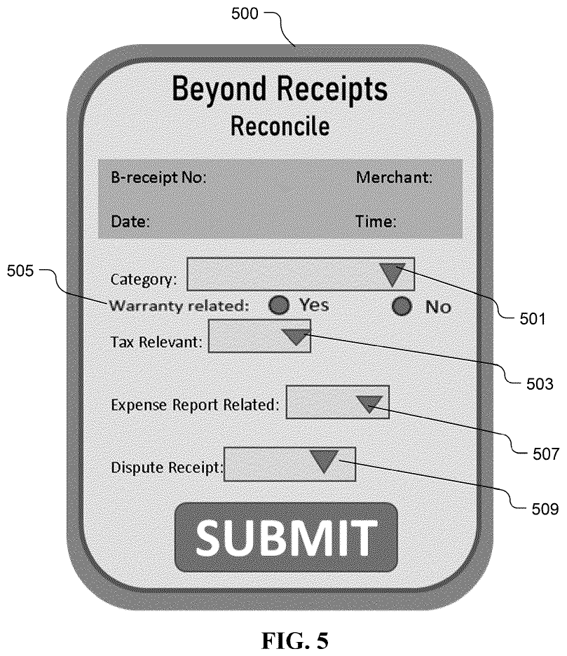

In some examples, the communication (e.g., the alert, the notification) received by a device (e.g., communication device 105, 107, 109 or 111) of the user from the network device 103 indicating the electronic receipt may be associated with a user input interface. For example, as shown in FIG. 5, the network device 103 may provide an exemplary user input interface 500 to a device of a user (e.g., a user having a BR account). The user input interface 500 may include a drop-down menu item 501 which may allow the user to choose which category, among multiple categories, the user may desire the electronic receipt to be labeled in association with the user's account. In some examples, these categories may be chosen or set up by the user in an instance in which the user setup their BR account. In some other examples, in an instance in which the consumer chooses not to establish custom categories, the network device 103 may provide default categories within the user input interface (e.g., user input interface 501) from which the user may select. In some examples, for purposes of illustration and not of limitation, the categories that may be chosen from the drop-down menu item 501 may include, but are not limited to groceries, fast food, restaurant, household, clothing, entertainment, and/or travel. In other examples, any other suitable categories may be chosen from the drop down menu item 501.

In response to selecting a desired category from the drop-down menu item 501, the associated electronic receipt may be tagged, by the device(s) (e.g., communication devices 105, 107, 109, 111) of the user, with the selected category. The device of the user may provide the indication of the selected category to the network device 103 which may enable filtering or searching of the electronic receipt based in part on the selected category, which may be associated with the user's account. In some examples, the network device 103 may provide the selected category to other systems (e.g., accounting systems) for analysis to perform various reporting functions.

In some other examples, the machine learning model 410 may be implemented by the network device 103 to enable the network device 103 to learn/predict which merchants/vendors that users of the system may make purchases. In addition, as disclosed herein, machine learning model 410 may be used to provide ancillary services to a merchant or purchaser based on the data of the consolidated receipts which are obtained from multiple purchasers.

For purposes of illustration and not of limitation, for example, based on analyzing training data (e.g., training data 420) over a time period involving a user's past transaction history, the network device 103 may determine that during the first week of each month of a current year, the user (e.g., User A) shops at Grocery Store A and that the user designates the receipts obtained during that time frame, e.g., the first week of each month, as having a grocery category. For instance, the user may have utilized the drop-down menu item 501 to select a grocery category for purchases obtained at Grocery Store A during the prior 3 months of a year for the first week of the three months. As such, in this example, in response to analyzing training data (e.g., training data 420) for a predetermined threshold period of time (e.g., 3 months) for the time period being examined (e.g., the first week of each month), the network device 103 implementing the machine learning model 410 may determine that the user has made the same type of transactions (e.g., groceries) at a same merchant(s)/vendor(s) (e.g., Grocery Store A) and that the user selected the grocery category for the transactions.

Accordingly, network device 103 by implementing the machine learning model 410 may predict that the current and future purchases made during the same time period (e.g., first week of each month) are from the same merchant/vendor and may predict the same category (e.g., grocery category). In some examples, the machine learning model 410 may utilize a prior period timeframe such as, for example, 3-6 months to evaluate one or more categories being selected by a user(s) in relation to a particular merchant(s) and/or vendor(s). In this manner, the machine learning model 410 may automatically prepopulate a category field on a notification that matches another transaction associated with the same particular merchant(s) and/or vendor(s) based on the historical information associated with the prior period timeframe. In some examples, this historical information associated with the prior period timeframe may be training data for the machine learning model 410. In this manner, based on the machine learning model 410 determining/estimating the category field on the notification such may alleviate the user from selecting the category associated with the notification. However, in some examples the user input interface (e.g., user input interface 500) associated with the notification may provide/present the user the opportunity to change the category if desired. For purposes of illustration and not of limitation, as an example the machine learning model 410 may determine/predict a category associated with a notification such as groceries associated with a transaction at a particular merchant because the historical information may indicate that the user purchased groceries from the particular merchant (e.g., during the 3-6 months). In this example, in instance in which the user actually purchased clothing from the particular merchant for this same transaction, the user may utilize the user input interface 500 to select the appropriate category from the drop-down menu item 501 to select the appropriate category such as for example clothing.

Additionally, the network device 103, based on implementing the machine learning model 410, may examine the content of a receipt associated with a current/future purchase to determine a confidence score/level that the predicted category of the machine learning model may be correct. For example, in an instance in which the network device 103 implementing the machine learning model 410 determines that a number of items on the receipt are equal to or exceed a predetermined threshold (e.g., greater than 50% (e.g., 51%, 75%, etc.)), the network device 103 implementing the machine learning model 410 may determine that the predicted category (e.g., grocery category) has a high probability (e.g., greater than 75%) of being correct. In an instance in which the network device implementing the machine learning model 410 determines that a number of items on the receipt are below the predetermined threshold (e.g., less than 50% (e.g., 49%, 40%, 35%, etc.)) the network device 103 implementing the machine learning model 410 may determine that the predicted category (e.g., grocery category) has a moderate to low probability (e.g., less than 50%) of being correct.

In an instance in which the network device 103 implements the machine learning model 410 to predict the category or a merchant/vendor, the network device 103 may send a user input interface 500 to a device (e.g., communication device 105, 107, 109, 111) associated with the user with a preselected category indicating the predicted category or predicted merchant/vendor. As such, the network device 103 may provide the user input interface 500 to be presented via a display (e.g., display 42) of a device (e.g., communication device 105) associated with the user in a fashion tailored/customized for the user based on the user's patterns and habits predicted/determined by the machine learning model 410. In response to receiving the user input interface 500, the user may change the predicted category to another category or may change the indication of the predicted merchant/vendor if the user desires. Although the herein example, which is for purposes of illustration and not of limitation, provided a grocery category example, in other examples the machine learning model 410 may predict any other suitable category (e.g., a hardware category, clothes category, etc.) or merchant/vendor (e.g., Hardware Store A, Clothing Store A, etc.) in a similar manner.

By determining the categories or determining the merchant(s)/vendor(s), based on machine learning this enables the network device 103 to conserve processing resources (e.g., processing conservation of central processing unit 91, co-processor 81), and may minimize network traffic (e.g., minimizing traffic (e.g., content, data) across network 104) based on not having to receive across the network, and process, manual user selections of categories of several users of the BR system 100 in each and every instance in a brute force manner. Since the machine learning model 410 may have determined some categories already for users that are accurate, the need for each and every user of the BR system to manual select categories and send such user manual selections across the network may be reduced enabling the network to operate more efficiently and conserve network bandwidth for other functions (e.g., other traffic).

Additionally, the machine learning model 410 may provide other technical benefits via/by the network device 103 based on increasing accuracy of category determinations over time period(s) as more training data (e.g., training data 420) may be obtained in real-time and stored in training database 430 and may automatically determine and provide addition of new categories in user input interfaces (e.g., user input interface 500), in real-time, for example as users purchase new types of goods or services. For instance, by analyzing new types of goods or services associated with users, the machine learning model 410 may determine new categories in real-time.

The machine learning model 410 of the Beyond Receipts system described herein provides technical benefits/advantages over existing receipt management systems by reducing/conserving network device (e.g., network device 103) processing resources and conserves network bandwidth (e.g., across network 104) based on providing efficient and accurate predictions/determinations regarding increasing accuracy of category determinations over time and predicting new categories in-real time. At present, some of these existing receipt management systems typically utilize brute force mechanisms for receipt generation and storage in which users may be required to perform more tasks to facilitate receipt management which may be cumbersome and cause electronic devices to perform additional steps/operations which inefficiently constrains processing resources and increases network traffic (e.g., due to additional network traffic associated with the additional steps/operations) and thus inefficiently conserves network bandwidth.

### Earmark the Receipt

The user input interface 500 may also enable a user to mark a receipt(s) for tracking purposes. In this regard, the user input interface 500 may include other input sections associated with tracking one or more receipts such as, for example, drop down menu taxes item 503, warranty item 505, and drop-down menu expense reporting item 507. The drop-down menu taxes item 503, drop down menu warranty item 505, and drop-down menu expense reporting item 507 may be utilized to enable easy sorting associated with receipts. For purposes of illustration and not of limitation, this sorting may be beneficial when preparing taxes, seeking evidence or information for a warranty (e.g., a purchased warranty), or for filing/submitting an expense report. Each of the drop-down menu items 503, and 507 may have an option for selection associated with a check box that may enable the user to select (e.g., via a finger or pointing device (e.g., a mouse device)) the check box to mark an associated receipt for the desired tracking purpose (e.g., taxes, expense reporting, etc.). The warranty item 505 may indicate selection fields of Yes and No as options for a user to mark an associated receipt(s) for a desired tracking purpose associated with one or more warranties. In response to detecting an indication of a selection to mark a receipt(s) for tracking purposes, a device (e.g., communication devices 105, 107, 109, 111) of a user may send a communication indicating such selection(s) to the network device 103 of the BR system 100 and the network device 103 (e.g., via the BR module 98) may associate such selected tracking purposes corresponding to a receipt with the user's account (e.g., BR account).

Additionally, the user input interface 500 may include a dispute receipt tab 509. In this regard, a user may utilize a finger, pointing device or the like to select the dispute receipt tab 509 which may cause prompts indicating Yes or No to be displayed associated with the dispute receipt tab 509, via the user input interface 500.

For example, in an instance in which a device (e.g., communication device 105) detects selection of an indication of Yes associated with the dispute receipt tab 509, the device may send a communication to network device 103 indicating that an associated receipt is valid. On the other hand, in an instance in which the device detects selection of an indication of No associated with the dispute receipt tab 509, the device may send a communication to network device 103 indicating that an associated receipt is invalid. In some examples, in response to the network device 102 receiving the communication that the associated receipt is invalid, the network device 103 may send a communication/notification to another system (e.g., a credit card system, a bank system) indicating that an associated transaction(s) is fraudulent and to stop payment associated with the transaction(s).

### Receipt Storage/Management

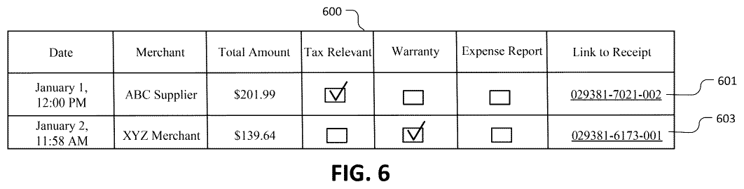

In response to receiving the communication indicating the selected tracking purposes by the network device 103, the network device 103 may store an associated receipt(s) in a repository (e.g., a BR repository) of a memory device (e.g., RAM 82). Prior to storing the receipt in the repository, the network device 103 may analyze the communication indicating the selected tracking purposes and other information associated with the receipt to generate header information associated with the receipt. Referring to FIG. 6, in this example, the network device 103 may generate the header information 600. The header information associated with a receipt may be logged, by the network device 103, into a tracking sheet (also referred to herein as tracker) corresponding to the user's account. In some examples, this information may include content such as the date and time of a purchase/transaction, the amount of the purchase/transaction, the merchant/vendor, or the like.

The content of the header information may also include a desired category associated with a corresponding receipt and the selected tracking purpose (e.g., taxes, warranty, expense reporting, etc.) associated with the receipt. Arranging the header information 600 may enable facilitation of quick searches, by devices (e.g., devices 105, 107, 109, 111) searching for transactions (e.g., searching within the repository) and information without the need for reviewing individual receipts. A link to the actual receipt may also be a part of the header information 600. As an example, the header information 600 may include a link to actual receipt 601 and link to actual receipt 603. Selection of the link to the actual receipt may enable a user to review additional details regarding the receipt associated with the link.

### The Repository

As described herein, each of the receipts associated with the system (e.g., BR system 100) may be stored in a repository (e.g., a cloud-based repository) by a memory device (e.g., RAM 82). In some examples, the repository may be managed by the network device (e.g., via the BR module 98) and may be associated with a main website (e.g., BR website) or individual webpages (e.g., user/entity specific BR webpages associated with user/entity BR accounts) of the users of the system (e.g., BR system 100). In some examples, each of the receipts header information (e.g., header information 600) may be included in a tracking sheet accessible via each webpage of a user or entity. As described herein, the header information may also have a link (e.g., link to receipt 601) to a corresponding full/complete receipt that may also be stored in the repository. In some examples, the receipts may be stored in the repository for a predetermined time period. Upon expiration of the predetermined time period, the network device 103 (e.g., via the BR module 98) may send one or more communications to devices of users having BR accounts in which the communication(s) may indicate an option to continue storage of the receipt within the repository, to download receipt information (e.g., header information 600), or to allow the network device 103 to delete a corresponding receipt from the repository.

In this regard, the BR system 100 provides a centralized repository in which a user having a BR account may have each/all of their receipts sent to and stored in the repository. As such, the BR system provides a comprehensive repository in which each/all electronic receipts associated with a user(s) may be sent, and the repository may enable access (e.g., by the user) to each/all of the electronic receipts of the user(s).

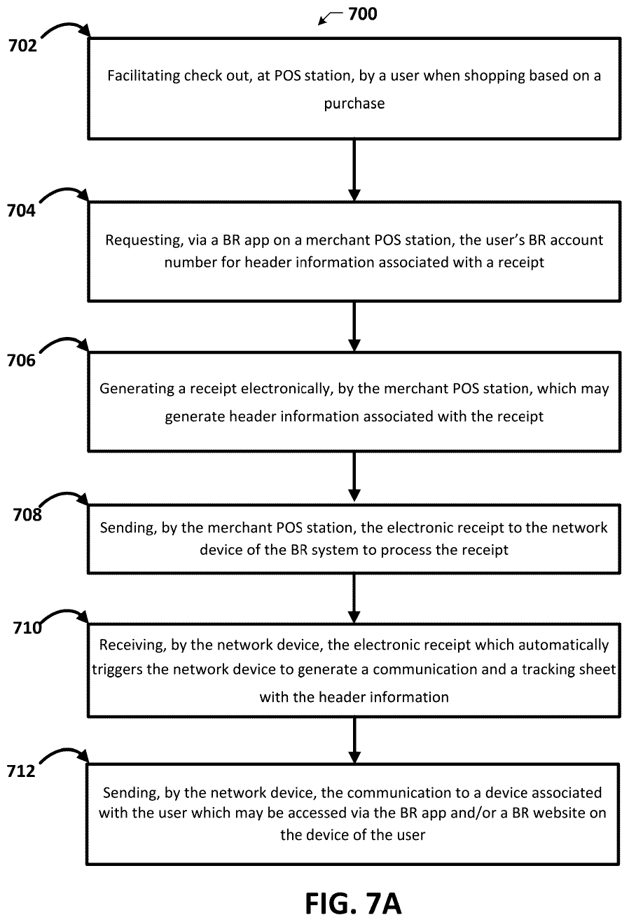

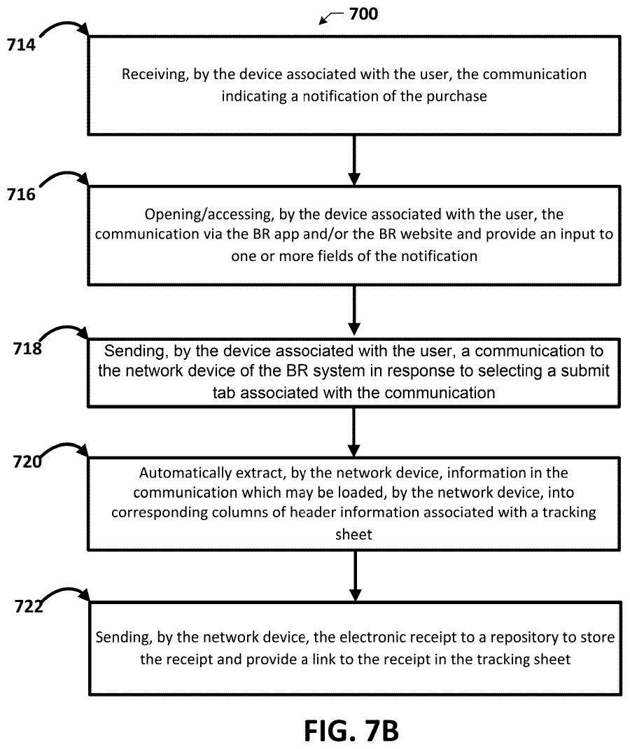

Referring to FIGS. 7A and 7B, an exemplary process of electronic receipt generation or management by the BR system based on a POS station facilitating a purchase/transaction is provided. In an example, the process 700 may be based in part on the POS station performing one or more functions associated with the BR app or a BR website. At operation 702, the process may include facilitating check out, at POS station (e.g., device 106), by a user when shopping based on completion of a purchase. At operation 704, the process may include a merchant (e.g., merchant station 101) requesting, via a BR app on the merchant POS station (e.g., device 106), the user's BR account number to facilitate generation of header information associated with a receipt.

At operation 706, the process may include generating the receipt electronically, by the merchant POS station, which may generate header information associated with the receipt (e.g., BR user account number, merchant/vendor account number, date and time of purchase, total purchase amount, etc.). At operation 708, the process may include sending, by the merchant POS station, the electronic receipt, to the network device 103 of the BR system to process the receipt. At operation 710, the process may include receiving, by the network device, the electronic receipt which automatically triggers the network device to generate a communication (e.g., a notification, an alert, etc.) and a tracking sheet with the header information (e.g., header information 600).

At operation 712, the process may include sending, by the network device, the communication to a device (e.g., communication device 105) associated with the user which may be accessed via the BR app or a BR website on or associated with the device of the user. In some examples, the network device may store the receipt in a holding folder until the reconcile process associated with the receipt is completed. At operation 714, the process may include receiving, by the device associated with the user, the communication indicating a notification of the purchase. In some examples, the indication of the notification of the purchase may be indicated in a BR activity folder associated with the user's BR account. At operation 716, the process may include opening/accessing, by the device associated with the user, the communication via the BR app or the BR website and may provide an input to one or more fields of the notification.

At operation 718, the process may include sending, by the device associated with the user, a communication (e.g., a notification, an alert) to the network device of the BR system in response to selecting a submit tab (e.g., submit tab 511) associated with the communication. At operation 720, the process may include automatically extracting, by the network device, information in the communication which may be loaded, by the network device, into corresponding columns of header information (e.g., header information 600) associated with a tracking sheet. At operation 722, the process may include sending, by the network device, the electronic receipt to a repository to store the receipt and provide a link (e.g., link to actual receipt 601) to the receipt in the tracking sheet.

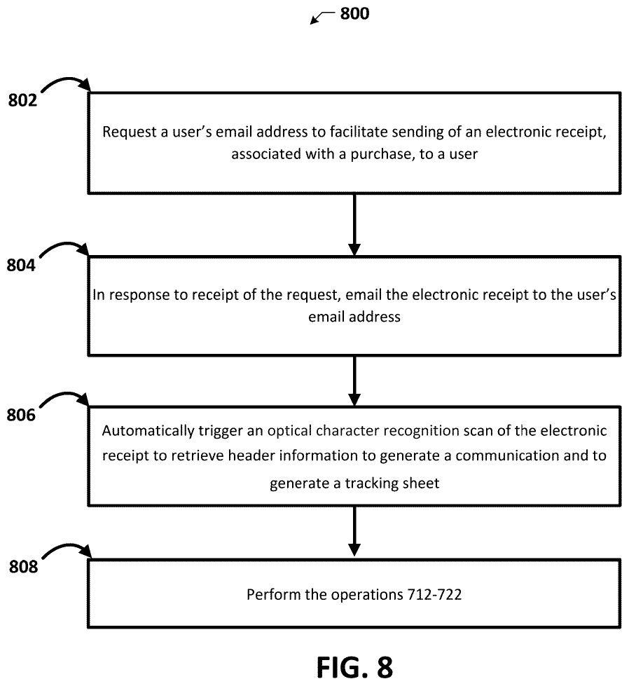

Referring to FIG. 8, an exemplary process of electronic receipt generation or management by the BR system according to another example of the present disclosure is provided. In an example, the process 800 may be based in part on the BR system facilitating a purchase or transaction without the merchant utilizing the BR app. For instance, in this example a POS station of a merchant or an online entity facilitating purchase of goods, services or other transactions may not have the BR app to utilize.

At operation 802, a device (e.g., network device 103) may request a user's email address (e.g., BR email address) to facilitate sending of an electronic receipt, associated with a purchase/transaction, to a user. At operation 804, in response to receipt of the request, a device (e.g., device 106, device 108) may email the electronic receipt to the user's email address.

At operation 806, a device (e.g., network device 103) may automatically trigger an optical character recognition (OCR) scan of the electronic receipt to retrieve header information to generate a communication and may generate a tracking sheet. The header information (e.g., header information 600) may be included in the communication and the tracking sheet. Subsequently, at process 808, the process 800 may include performing the operations 712-722 (of FIGS. 7A and 7B). In response to completing the performing of operations 712-722, the process 800 may end.

In some examples, the BR system 100 may also facilitate returns of goods or services. For instance, a user may be able to access a receipt stored in the BR system to facilitate a return. As such, the user may access the receipt in the repository via the BR app or a BR website and may retrieve the receipt which may have a quick-response (QR) code that a merchant/vendor device may scan, for example by a POS station. In response to scanning the QR code associated with the receipt, the merchant may determine the receipt is valid and that an associated good(s)/service(s) was prior purchased at the merchant and may facilitate the return of the good(s)/service(s) on behalf of the user.

In some other examples, the BR system may facilitate/process electronic receipts in similar fashion described herein associated with a donation(s) for a user having a BR account in which the user may or may not receive a product, good or service for the donation(s).

Referring to FIG. 9, an exemplary process 900 of electronic receipt generation or management according to another example of the present disclosure is provided. At operation 902, a device (e.g., network device 103) may determine completion of a transaction, facilitated by an entity, on behalf of at least one user.

At operation 904, a device (e.g., network device 103) may receive at least one electronic receipt generated by the entity to determine one or more items of information from the electronic receipt in response to determining that the at least one user comprises a user account (e.g., a BR account) associated with facilitating electronic receipts from the one or more users. The electronic receipts may be associated with the at least one user.

At operation 906, a device (e.g., network device 103) may predict by performing machine learning based on analyzing items of training data associated with one or more determined prior transactions by the at least one user associated with a historical time period, at least one category associated with one or more items associated with the transaction and predicting the entity. The device (e.g., network device 103) may predict by performing the machine learning based in part on implementing/executing the machine learning model 410. In some examples, the training data may be training data 420.

At operation 908, a device (e.g., network device 103) may provide a generated communication to a device of the user. The communication may indicate the predicted at least one category and the predicted entity. In some examples, the device of the user may be communication device 105, 107, 109 or 111. In some examples, the communication may include a user interface (e.g., user input interface 500). At operation 910, a device (e.g., network device 103) may receive an indication from the device associated with the user indicating whether the transaction is valid or invalid.

The device (e.g., network device 103) may determine, based on a determined confidence score, a probability that the prediction of the at least one category is correct based on analyzing the training data (e.g., training data 420) and one or more content items associated with the electronic receipt. In some examples, the content items may be associated with some of the data (e.g., purchased items) indicated on the electronic receipt.

The device (e.g., network device 103) may determine that the prediction of the at least one category is correct in response to determining the probability equals or exceeds a predetermined threshold (e.g., 75% or greater, etc.). In some examples, the historical time period may comprise a predetermined time period (e.g., four months, three months) prior to a current or future time period associated with the user facilitating transactions.

The device (e.g., network device 103) may also include the header information (e.g., header information 600) in a tracker (e.g., a tracker sheet) comprising other information associated with one or more other transactions (e.g., link to receipt 603) with one or more entities by the at least one user. The header information may also include information associated with a currently received electronic receipt (e.g., link to receipt 601).

In some examples, the generated communication provided to the device of the user may comprise a user interface (e.g., user input interface 500) enabling selection of one or more marking items to assign to the electronic receipt to facilitate tracking of the electronic receipt. In some examples, the marking items may be tracking areas/features such as taxes, warranty, or expense reporting. In other examples, the marking items may be any other suitable tracking areas/features to track an electronic receipt(s). In some examples, an electronic receipt(s) may be searched and retrieved, by the network device 103, from a repository stored in a memory (e.g., RAM 82) based in part on an assigned marking item (e.g., taxes) to the electronic receipt(s).

In consideration of FIG. 4, FIG. 9 (e.g., step 906, etc.), and other subject matter herein, the disclosed BR system may use machine learning model 410 for certain alternative or additional data-based services that may be provided to a merchant or purchaser, based on the consolidated receipt data that may be obtained or analyzed. For example, machine learning model 410 may be used to generate recommendations (e.g., predictions) for a merchant in stocking/preparing their site with products/services. The recommendations may include the timing or number of certain products or services.

Machine learning (ML) model 410 may be used for recommending products or services, among other things to a merchant or purchaser, which may be an individual account or group account (e.g., family, business, city, region). In an example, based on the receipt data a first merchant may receive information about purchase decisions of a user at a second merchant. The first merchant and second merchant having respective computing systems. The first merchant and the second merchant may be identified as a similar merchant (e.g., hardware, groceries, electronics, etc.). The user may shop at the first merchant and second merchant but may buy different products or services at each merchant. The first merchant may be provided a recommendation to stock an item not previously in stock or stock an existing item at a different price point.

As can be observed, the disclosed methods and systems help obtain information (i.e., data) associated with purchasing habits of users individually or collectively. This information may be useful for the manufacturer (or service provider), the primary merchant (e.g., grocery store), third-party unrelated merchant (fitness studio), or the like. In an example, a third-party merchant may subscribe to the Beyond Receipts system. Using ML or artificial intelligence (AI) (e.g., generative AI), the third-party merchant may receive a response to a request for areas in which a threshold number of individuals are purchasing healthy foods (or alternatively unhealthy foods). The response may be a map, list, or other information of one or more areas that is responsive to the aforementioned request. Such information may be used by a third-party merchant to help determine whether to place a certain type of real estate (e.g., fitness studio or specialized health food store) in the area. In an alternative way to approach a similar situation, a third-party merchant may send a request to the Beyond Receipts system for the best locations to place a certain type of business (e.g., fitness studio). In response, the Beyond Receipts system may use ML or AI (e.g., ML model 410) with information associated with individual purchases (e.g., ratios of vegetables to starches, etc.) and provide a list of locations. Other examples may include using ML with the use of Beyond Receipts system information to diagnose why a merchant may be successful or unsuccessful. It should be noted that this Beyond Receipts system may be different from other systems since it may provide granular insight on the products purchased (which may include in-person and online).

In another example, machine learning model 410 may be used to recommend weekly or monthly purchasing lists (e.g., grocery list) to a user, which may be based on the consolidated receipt information (e.g., groceries from different stores) and further recommend how to reduce cost via purchasing items at one or more sources (e.g., online stores or in-person), which may include example recommendations for a user to consolidate their purchases at one source or order from multiple sources. This recommendation may be based on data such as price, distance from home, frequency of purchase, or other information associated with the receipts. The method or system associated with FIG. 9 may be altered to integrate the disclosed alternative or additional machine learning uses herein. The terms machine learning (ML) and artificial intelligence (AI) may be used interchangeably herein.

Additionally, contrary to conventional computing systems that use central processing units (CPUs), in some examples the disclosed Beyond Receipt system(s) may primarily use graphics processing units (GPUs), field-programmable gate arrays (FPGAs), or application-specific integrated circuits (ASICs), which may be referenced herein as AI chips, for executing the disclosed methods. Unlike CPUs, AI chips may have optimized design features that may dramatically accelerate the identical, predictable, independent calculations required by AI applications and/or AI algorithms. They include executing a large number of calculations in parallel rather than sequentially, as in CPUs; calculating numbers with low precision in a way that successfully implements AI applications and/or AI algorithms but reduces the number of transistors needed for the same calculation(s); speeding up memory access by, for example, storing an entire AI application and/or AI algorithm in a single AI chip; and using programming languages built specifically to efficiently translate AI computer code for execution on an AI chip. Different types of AI chips are useful for different tasks. GPUs may be used for initially developing and refining AI applications and/or AI algorithms; this process is known as “training.” FPGAs may be used to apply trained AI applications and/or AI algorithms to real-world data inputs; this is often called “inference.” ASICs may be designed for either training or inference.

### ALTERNATIVE EXAMPLES

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

Some portions of this description describe the examples in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one example, a software module is implemented with a computer program product comprising a computer-readable medium containing computer program code, which can be executed by a computer processor for performing any or all of the steps, operations, or processes described.

Examples also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples also may relate to a product that is produced by a computing process described herein. Such a product may comprise information resulting from a computing process, where the information is stored on a non-transitory, tangible computer readable storage medium and may include any example of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims. In addition, the use of the word “or” is generally used inclusively unless otherwise provided herein.

What is claimed:

1. A method comprising:
determining completion of a transaction, facilitated by an entity, on behalf of at least one user;
receiving at least one electronic receipt generated by the entity to determine one or more items of information from the electronic receipt in response to determining that the at least one user comprises a user account associated with facilitating electronic receipts, associated with the at least one user, from one or more entities;
predicting, by the network device by performing machine learning based on analyzing items of training data associated with one or more determined prior transactions by the at least one user associated with a historical time period, at least one category associated with one or more items associated with the transaction and predicting the entity;
providing, by the network device, a generated communication to a device of the user, the communication indicating the predicted at least one category and the predicted entity; and
receiving an indication from the device indicating whether the transaction is valid or invalid.

2. The method of claim 1, further comprising:
storing the electronic receipt in a memory on behalf of the at least one user in response to the determining that the at least one user comprises the user account associated with facilitating electronic receipts and in response to determining that the transaction is valid.

3. The method of claim 1, further comprising:
determining that the transaction is valid in response to receipt of an indication selected from a user interface within the communication indicating that the transaction is valid.

4. The method of claim 2, further comprising:
enabling the user to access the memory to retrieve the electronic receipt or one or more other electronic receipts associated with other transactions by the at least one user.

5. The method of claim 1, further comprising:
determining, based on a determined confidence score, a probability that the predicting of the at least one category is correct based on analyzing the training data and one or more content items associated with the electronic receipt.

6. The method of claim 5, further comprising:
determining that the predicting of the at least one category is correct in response to the determining the probability equals or exceeds a predetermined threshold.

7. The method of claim 1, wherein the historical time period comprises a predetermined time period prior to a current or future time period associated with the at least one user facilitating transactions.

8. The method of claim 1, further comprising:
automatically extracting one or more data items from the electronic receipt to generate header information comprising a subset of content associated with the electronic receipt in response to determining that the transaction is valid.

9. The method of claim 1, further comprising:
including the header information in a tracker comprising other information associated with one or more other transactions with one or more entities by the at least one user.

10. The method of claim 1, wherein the communication comprises a user interface enabling selection of one or more marking items to assign to the electronic receipt to facilitate tracking of the electronic receipt.

11. An apparatus comprising:
one or more processors; and
at least one memory storing instructions, that when executed by the one or more processors, cause the apparatus to:
determine completion of a transaction, facilitated by an entity, on behalf of at least one user;
receive at least one electronic receipt generated by the entity to determine one or more items of information from the electronic receipt in response to determining that the at least one user comprises a user account associated with facilitating electronic receipts, associated with the at least one user, from one or more entities;
predict by performing machine learning based on analyzing items of training data associated with one or more determined prior transactions by the at least one user associated with a historical time period, at least one category associated with one or more items associated with the transaction and predicting the entity;
provide a generated communication to a device of the user, the communication indicating the predicted at least one category and the predicted entity; and
receive an indication from the device indicating whether the transaction is valid or invalid.

12. The apparatus of claim 11, wherein when the one or more processors further execute the instructions, the apparatus is configured to:
store the electronic receipt in a memory on behalf of the at least one user in response to the determine that the at least one user comprises the user account associated with facilitating electronic receipts and in response to determining that the transaction is valid.

13. The apparatus of claim 11, wherein when the one or more processors further execute the instructions, the apparatus is configured to:
determine that the transaction is valid in response to receipt of an indication selected from a user interface within the communication indicating that the transaction is valid.

14. The apparatus of claim 12, wherein when the one or more processors further execute the instructions, the apparatus is configured to:
enable the user to access the memory to retrieve the electronic receipt or one or more other electronic receipts associated with other transactions by the at least one user.

15. The apparatus of claim 11, wherein when the one or more processors further execute the instructions, the apparatus is configured to:
determine, based on a determined confidence score, a probability that the predict of the at least one category is correct based on analyzing the training data and one or more content items associated with the electronic receipt.

16. The apparatus of claim 15, wherein when the one or more processors further execute the instructions, the apparatus is configured to:
determine that the predicting of the at least one category is correct in response to the determine the probability equals or exceeds a predetermined threshold.

17. The apparatus of claim 11, wherein the historical time period comprises a predetermined time period prior to a current or future time period associated with the at least one user facilitating transactions.

18. A non-transitory computer-readable medium storing instructions that, when executed, cause:
determining completion of a transaction, facilitated by an entity, on behalf of at least one user;
receiving at least one electronic receipt generated by the entity to determine one or more items of information from the electronic receipt in response to determining that the at least one user comprises a user account associated with facilitating electronic receipts, associated with the at least one user, from one or more entities;
predicting, by the network device by performing machine learning based on analyzing items of training data associated with one or more determined prior transactions by the at least one user associated with a historical time period, at least one category associated with one or more items associated with the transaction and predicting the entity;
providing, by the network device, a generated communication to a device of the user, the communication indicating the predicted at least one category and the predicted entity; and
receiving an indication from the device indicating whether the transaction is valid or invalid.

19. The non-transitory computer-readable medium of claim 18, wherein the instructions, when executed, further cause:
determining, based on a determined confidence score, a probability that the predicting of the at least one category is correct based on analyzing the training data and one or more content items associated with the electronic receipt.

20. The non-transitory computer-readable medium of claim 19, wherein the instructions, when executed, further cause:
determining that the predicting of the at least one category is correct in response to the determining the probability equals or exceeds a predetermined threshold.
